(19) United States
(12) Patent Application Publication
(10) Pub. No.: US 2023/0059313 A1
(43) Pub. Date: Feb. 23, 2023

(54) ON WAFER DIMENSIONALITY REDUCTION

(71) Applicant: Applied Materials, Inc., Santa Clara, CA (US)

(72) Inventor: Joshua Thomas Maher, Sunnyvale, CA (US)

(21) Appl. No.: 17/886,353

(22) Filed: Aug. 11, 2022

Related U.S. Application Data
(60) Provisional application No. 63/234,654, filed on Aug. 18, 2021.

(51) Int. Cl. G06N 3/08; G06N 3/04

(52) U.S. Cl. CPC G06N 3/08; G06N 3/0454

(57) ABSTRACT

A method includes receiving first metrology data associated with first substrates produced by manufacturing equipment. The method further includes training a first machine learning model with data input including the first metrology data to generate a first trained machine learning model. The first trained machine learning model is capable of reducing dimensionality of second metrology data associated with second substrates produced by second manufacturing equipment to perform corrective actions associated with the second manufacturing equipment.

### RELATED APPLICATION

This application claims the benefit of U.S. Provisional Application No. 63/234,654, filed Aug. 18, 2021, the content of which is hereby incorporated by reference in its entirety.

### TECHNICAL FIELD

The present disclosure relates to dimensionality reduction, and, more particularly, on wafer dimensionality reduction.

### BACKGROUND

Products may be produced by performing one or more manufacturing processes using manufacturing equipment. For example, semiconductor manufacturing equipment may be used to produce substrates via semiconductor manufacturing processes. Products are to be produced with particular properties, suited for a target application.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In an aspect of the disclosure, a method includes receiving first metrology data associated with first substrates produced by first manufacturing equipment. The method further includes training a first machine learning model with data input including the first metrology data to generate a first trained machine learning model. The first trained machine learning model is capable of reducing dimensionality of second metrology data associated with second substrates produced by second manufacturing equipment to perform one or more corrective actions associated with the second manufacturing equipment.

In another aspect of the disclosure, a method includes receiving metrology data associated with substrates produced by manufacturing equipment and providing the metrology data as input to a first trained machine learning model to reduce dimensionality of the metrology data to generate compressed data. The method further includes obtaining, from the first trained machine learning model, the compressed data and causing, based on the compressed data, performance of one or more corrective actions associated with the manufacturing equipment.

In another aspect of the disclosure, a non-transitory machine-readable storage medium storing instructions which, when executed, cause a processing device to perform operations. The operations include receiving first metrology data associated with first substrates produced by first manufacturing equipment. The operations further includes training a first machine learning model with data input including the first metrology data to generate a first trained machine learning model. The first trained machine learning model is capable of reducing dimensionality of second metrology data associated with second substrates produced by second manufacturing equipment to perform one or more corrective actions associated with the second manufacturing equipment.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to certain embodiments.

FIGS. 2A-B illustrate data set generators to create data sets for machine learning models, according to certain embodiments.

FIGS. 3A-B are block diagrams illustrating determining predictive data, according to certain embodiments.

FIGS. 4A-E are flow diagrams of methods associated with generating predictive data to cause a corrective action, according to certain embodiments.

FIG. 5 is illustrates operations of a machine learning model, according to certain embodiments.

FIG. 6 is a block diagram illustrating a computer system, according to certain embodiments.

### DETAILED DESCRIPTION

Described herein are technologies related to on wafer (e.g., metrology data of substrates) dimensionality reduction (e.g., for reduction of target variables, reducing dimensionality of data associated with substrates, and the use of this compressed data). Manufacturing equipment may be used to produce products, such as substrates (e.g., wafers, semiconductors). The properties of the produced substrates are to meet target properties for specific functionalities. Manufacturing parameters are to be selected to attempt to produce substrates that meet target properties. There are many manufacturing parameters (e.g., hardware parameters, process parameters, etc.) that cause the resulting properties of substrates. Conventional systems perform a cycle of selecting manufacturing parameters, producing substrates, determining properties of the substrates, and determining whether the properties match target properties, and then repeating that cycle with updated manufacturing parameters until the properties match the target properties. This process is very time consuming, wastes substrates, and wastes energy. With so many manufacturing parameters to choose from and limited time and material, this process often results in sub-optimal manufacturing parameters and sub-optimal products.

A machine learning model can be used to select manufacturing parameters. Over many manufacturing processes, a machine learning model can be trained to recognize correlations between manufacturing parameters (e.g., settings input to the processing or hardware equipment, readings from sensors during the process, etc.) and metrology data associated with substrates produced based on the manufacturing parameters. The trained machine learning model can be used to predict what inputs are likely to produce a target output.

Metrology data can be highly multi-dimensional (e.g., high on wafer dimensionality), with, for instance, thousands of data points describing a single substrate. Metrology data in this form is cumbersome to work with, slowing down manipulation and processing of the data, and is a problem particularly for machine learning models, which conventionally are trained on many examples to attempt to accurately predict a large number of target manufacturing parameters to result in substrates that meet target properties. In practical terms, such volume of training data may be unavailable, in addition to the inconvenience of working with large data sets, such as an increased energy consumption, processor overhead, and bandwidth used.

In some conventional systems, a subset of the manufacturing parameters are considered. For example, temperature and pressure are considered while ignoring the hundreds or thousands of other manufacturing parameters. This results in sub-optimal manufacturing parameters and sub-optimal products since many of the manufacturing parameters are not considered. Even with less manufacturing parameters to process, this conventional approach still has much metrology data to process, which results in increased energy consumption, processor overhead, and bandwidth used.

The methods and devices of the present disclosure address at least these deficiencies of conventional solutions. In some embodiments, a processing device receives first metrology data of first substrates produced by manufacturing equipment. The processing device provides the first metrology data as data input to train a first machine learning model to generate a trained machine learning model. The training of the first machine learning model may include reducing dimensionality of the first metrology data (e.g., finding a non-linear fit to reduce the dimensionality) to form first compressed data and generating, based on the first compressed data, first reconstructed data that is substantially similar to the first metrology data.

The first trained machine learning model is configured to receive data input of second metrology data associated with substrates produced by second manufacturing equipment and to reduce the dimensionality of the second metrology data to produce second compressed data. In some embodiments, the trained machine learning model reduces the dimensionality of the second metrology data using non-linear correlations in the second metrology data to generate the second compressed data. One or more corrective actions may be performed based on the second compressed data.

The second metrology data is associated with second substrates that were produced by second manufacturing equipment. Second manufacturing parameters (e.g., sensor data, hardware set points, process recipe, etc.) are associated with the manufacturing of the second substrates (e.g., processing parameters, hardware parameters, sensor data, etc.). In some embodiments, a second machine learning model is trained using data input of the second manufacturing parameters (e.g., sensor data) and target output of the second compressed data to generate a second trained machine learning model. In some embodiments, manufacturing parameters (e.g., of a process recipe) may be input into the second trained machine learning model and predicted metrology data may be output. In some embodiments, the model is inverted and target metrology data is input into the inverted model and manufacturing parameters are output. In some embodiments, sensor data associated with producing substrates is input into the trained model and predicted metrology data is output (e.g., to avoid performing metrology operations).

Aspects of the present disclosure result in technological advantages compared to conventional solutions. The present disclosure results in reduced processor overhead, energy consumption, and bandwidth used by using compressed data instead of massive amounts of metrology data. The present disclosure may result in performing less metrology operations since less features of metrology data may be used compared to conventional solutions. The present disclosure may result in predicting metrology data of substrates instead of conventional solutions of performing metrology operations for all of the substrates. Aspects of the present disclosure also result in using metrology data from fewer substrates which reduces the material used compared to conventional solutions. The present disclosure may reduce the dimensionality of the metrology data (e.g., target output variable space), resulting in a smaller number of substrates to be produced and studied compared to conventional solutions.

In some embodiments, the present disclosure describes providing metrology data as data input to train a machine learning model and as input to a trained machine learning model to generate compressed data (e.g., compressed metrology data) for training a second model. In some embodiments, the sensor data may be provided as data input to train a machine learning model and as input to a trained machine learning model to generate compressed data (e.g., compressed sensor data) for training a second model.

In some embodiments, the present disclosure describes generating compressed data (e.g., compressed metrology data, compressed sensor data) for training a second model. In some embodiments, the compressed data can be used for other processes (e.g., analytics, heuristics, to generate a look-up table, comparing compressed data to other compressed data, etc.) other than training a machine learning model.

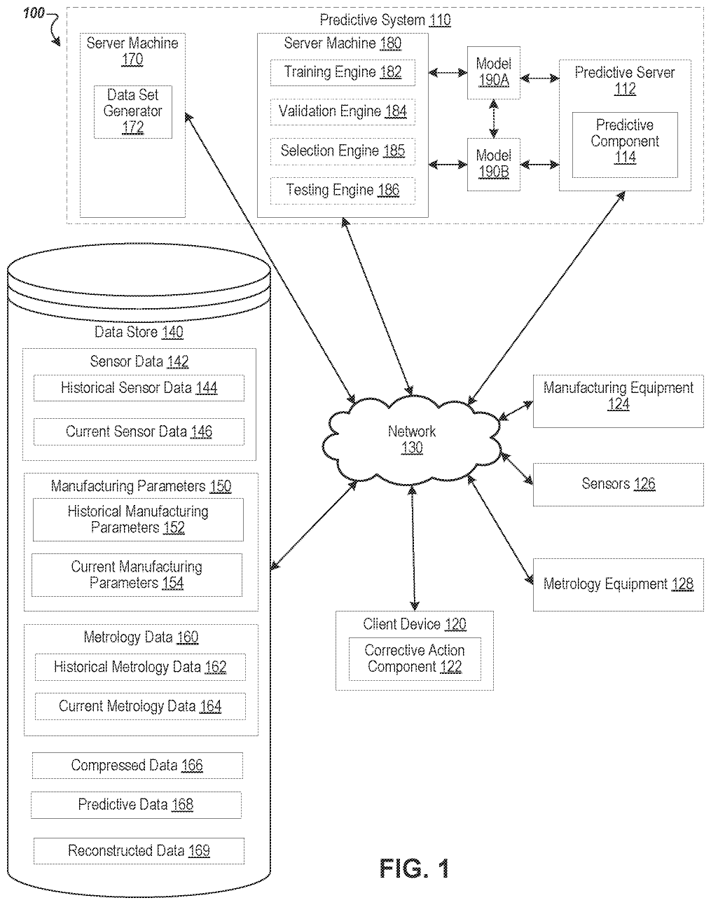

FIG. 1 is a block diagram illustrating an exemplary system 100 (exemplary system architecture), according to certain embodiments. The system 100 includes a client device 120, manufacturing equipment 124, sensors 126, metrology equipment 128, a predictive server 112, and a data store 140. The predictive server 112 may be part of a predictive system 110. The predictive system 110 may further include server machines 170 and 180.

The sensors 126 may provide sensor data 142 associated with manufacturing equipment 124 (e.g., associated with producing, by manufacturing equipment 124, corresponding products, such as substrates). The sensor data 142 may be used for equipment health and/or product health (e.g., product quality). The manufacturing equipment 124 may produce products following a recipe or performing runs over a period of time. In some embodiments, the sensor data 142 may include values of one or more of temperature (e.g., heater temperature), spacing (SP), pressure, High Frequency Radio Frequency (HFRF), voltage of Electrostatic Chuck (ESC), electrical current, flow, power, voltage, etc. Sensor data 142 may be associated with or indicative of manufacturing parameters such as hardware parameters (e.g., settings or components (e.g., size, type, etc.) of the manufacturing equipment 124 or process parameters of the manufacturing equipment 124. Data associated with some hardware parameters may, instead or additionally, be stored as manufacturing parameters 150, which may include historical manufacturing parameters 152 and current manufacturing parameters 154. Manufacturing parameters 150 may be indicative of input settings to the manufacturing device (e.g., heater power, gas flow, etc.). The sensor data 142 and/or manufacturing parameters 150 may be provided while the manufacturing equipment 124 is performing manufacturing processes (e.g., equipment readings when processing products). The sensor data 142 may be different for each product (e.g., each substrate).

In some embodiments, the sensor data 142, metrology data 160, or manufacturing parameters 150 may be processed (e.g., by the client device 120 and/or by the predictive server 112). Processing of the sensor data 142 may include generating features. In some embodiments, the features are a pattern in the sensor data 142, metrology data 160, and/or manufacturing parameters 150 (e.g., slope, width, height, peak, etc.) or a combination of values from the sensor data 142, metrology data, and/or manufacturing parameters (e.g., power derived from voltage and current, etc.). The sensor data 142 may include features and the features may be used by the predictive component 114 for performing signal processing and/or for obtaining predictive data 168 for performance of a corrective action.

Each instance (e.g., set) of sensor data 142 may correspond to a product (e.g., a substrate), a set of manufacturing equipment, a type of substrate produced by manufacturing equipment, or the like. Each instance of metrology data 160 and manufacturing parameters 150 may likewise correspond to a product, a set of manufacturing equipment, a type of substrate produced by manufacturing equipment, or the like. The data store may further store information associating sets of different data types, e.g. information indicative that a set of sensor data, a set of metrology data, and a set of manufacturing parameters are all associated with the same product, manufacturing equipment, type of substrate, etc.

In some embodiments, the predictive system 110 may generate predictive data 168 using supervised machine learning (e.g., supervised data set, predictive data 168 includes metrology data, etc.). In some embodiments, the predictive system 110 may generate predictive data 168 using semi-supervised learning (e.g., semi-supervised data set, predictive data 168 is a predictive percentage, etc.). In some embodiments, the predictive system 110 may generate predictive data 168 using unsupervised machine learning (e.g., unsupervised data set, clustering, clustering based on metrology data 160, etc.).

The client device 120, manufacturing equipment 124, sensors 126, metrology equipment 128, predictive server 112, data store 140, server machine 170, and server machine 180 may be coupled to each other via a network 130 for generating predictive data 168 to perform corrective actions.

In some embodiments, network 130 is a public network that provides client device 120 with access to the predictive server 112, data store 140, and other publicly available computing devices. In some embodiments, network 130 is a private network that provides client device 120 access to manufacturing equipment 124, sensors 126, metrology equipment 128, data store 140, and other privately available computing devices. Network 130 may include one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

The client device 120 may include a computing device such as Personal Computers (PCs), laptops, mobile phones, smart phones, tablet computers, netbook computers, network connected televisions (“smart TV”), network-connected media players (e.g., Blu-ray player), a set-top-box, Over-the-Top (OTT) streaming devices, operator boxes, etc. The client device 120 may include a corrective action component 122. Corrective action component 122 may receive user input (e.g., via a Graphical User Interface (GUI) displayed via the client device 120) of an indication associated with manufacturing equipment 124. In some embodiments, the corrective action component 122 transmits the indication to the predictive system 110, receives output (e.g., predictive data 168) from the predictive system 110, determines a corrective action based on the output, and causes the corrective action to be implemented. In some embodiments, the corrective action component 122 obtains sensor data 142 (e.g., current sensor data 146) associated with the manufacturing equipment 124 (e.g., from data store 140, etc.) and provides the sensor data 142 (e.g., current sensor data 146) associated with the manufacturing equipment 124 to the predictive system 110. In some embodiments, the corrective action component 122 stores sensor data 142 in the data store 140 and the predictive server 112 retrieves the sensor data 142 from the data store 140. In some embodiments, the predictive server 112 may store output (e.g., predictive data 168) of the trained machine learning model(s) 190 in the data store 140 and the client device 120 may retrieve the output from the data store 140. In some embodiments, the corrective action component 122 receives an indication of a corrective action from the predictive system 110 and causes the corrective action to be implemented. Each client device 120 may include an operating system that allows users to one or more of generate, view, or edit data (e.g., indication associated with manufacturing equipment 124, corrective actions associated with manufacturing equipment 124, etc.).

In some embodiments, the historical metrology data 162 corresponds to historical property data of products (e.g., produced using manufacturing parameters associated with historical sensor data 144 and historical manufacturing parameters 152) and the predictive data 168 is associated with predicted property data (e.g., of products to be produced or that have been produced in conditions recorded by current sensor data 146 and/or current manufacturing parameters 154). In some embodiments, the predictive data 168 is predicted metrology data (e.g., virtual metrology data) of the products to be produced or that have been produced according to conditions recorded as current sensor data 146 and/or current manufacturing parameters 154. In some embodiments, the predictive data 168 is an indication of abnormalities (e.g., abnormal products, abnormal components, abnormal manufacturing equipment 124, abnormal energy usage, etc.) and one or more causes of the abnormalities. In some embodiments, the predictive data 168 is an indication of change over time or drift in some component of manufacturing equipment 124, sensors 126, metrology equipment 128, and the like. In some embodiments, predictive data 168 is an indication of an end of life of a component of manufacturing equipment 124, sensors 126, metrology equipment 128, or the like.

Performing manufacturing processes that result in defective products can be costly in time, energy, products, components, manufacturing equipment 124, the cost of identifying the defects and discarding the defective product, etc. By inputting sensor data 142 (e.g., manufacturing parameters that are being used or are to be used to manufacture a product), receiving output of predictive data 168, and performing a corrective action based on the predictive data 168, system 100 can have the technical advantage of avoiding the cost of producing, identifying, and discarding defective products.

Performing manufacturing processes that result in failure of the components of the manufacturing equipment 124 can be costly in downtime, damage to products, damage to equipment, express ordering replacement components, etc. By inputting sensor data 142 (e.g., manufacturing parameters that are being used or are to be used to manufacture a product), receiving output of predictive data 168, and performing corrective action (e.g., predicted operational maintenance, such as replacement, processing, cleaning, etc. of components) based on the predictive data 168, system 100 can have the technical advantage of avoiding the cost of one or more of unexpected component failure, unscheduled downtime, productivity loss, unexpected equipment failure, product scrap, or the like. Monitoring the performance over time of components, e.g. manufacturing equipment 124, sensors 126, metrology equipment 128, and the like, may provide indications of degrading components.

Manufacturing parameters may be suboptimal for producing product which may have costly results of increased resource (e.g., energy, coolant, gases, etc.) consumption, increased amount of time to produce the products, increased component failure, increased amounts of defective products, etc. By inputting the sensor data 142 into the trained machine learning model 190, receiving an output of predictive data 168, and performing (e.g., based on the predictive data 168) a corrective action of updating manufacturing parameters (e.g., setting optimal manufacturing parameters), system 100 can have the technical advantage of using optimal manufacturing parameters (e.g., hardware parameters, process parameters, optimal design) to avoid costly results of suboptimal manufacturing parameters.

Corrective action may be associated with one or more of Computational Process Control (CPC), Statistical Process Control (SPC) (e.g., SPC on electronic components to determine process in control, SPC to predict useful lifespan of components, SPC to compare to a graph of 3-sigma, etc.), Advanced Process Control (APC), model-based process control, preventative operative maintenance, design optimization, updating of manufacturing parameters, updating manufacturing recipes, feedback control, machine learning modification, or the like.

In some embodiments, the corrective action includes providing an alert (e.g., an alarm to stop or not perform the manufacturing process if the predictive data 168 indicates a predicted abnormality, such as an abnormality of the product, a component, or manufacturing equipment 124). In some embodiments, the corrective action includes providing feedback control (e.g., modifying a manufacturing parameter responsive to the predictive data 168 indicating a predicted abnormality). In some embodiments, the corrective action includes providing machine learning (e.g., modifying one or more manufacturing parameters based on the predictive data 168). In some embodiments, performance of the corrective action includes causing updates to one or more manufacturing parameters.

Manufacturing parameters may include hardware parameters (e.g., replacing components, using certain components, replacing a processing chip, updating firmware, etc.) and/or process parameters (e.g., temperature, pressure, flow, rate, electrical current, voltage, gas flow, lift speed, etc.). In some embodiments, the corrective action includes causing preventative operative maintenance (e.g., replace, process, clean, etc. components of the manufacturing equipment 124). In some embodiments, the corrective action includes causing design optimization (e.g., updating manufacturing parameters, manufacturing processes, manufacturing equipment 124, etc. for an optimized product). In some embodiments, the corrective action includes a updating a recipe (e.g., manufacturing equipment 124 to be in an idle mode, a sleep mode, a warm-up mode, etc.).

The predictive server 112, server machine 170, and server machine 180 may each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

The predictive server 112 may include a predictive component 114. In some embodiments, the predictive component 114 may receive current sensor data 146, and/or current manufacturing parameters 154 (e.g., receive from the client device 120, retrieve from the data store 140) and generate output (e.g., predictive data 168) for performing corrective action associated with the manufacturing equipment 124 based on the current data. In some embodiments, the predictive component 114 may use one or more trained machine learning models 190 to determine the output for performing the corrective action based on current data.

In some embodiments, metrology data 160 may be provided to trained machine learning model 190A. This metrology data may be historical metrology data 162 or current metrology data 164. Machine learning model 190A may be used to dimensionally reduce the metrology data. The dimensional reduction may be performed using a non-linear fit, where machine learning model 190A is trained to find non-linear correlations in metrology data to dimensionally reduce the data to a compressed form, and verify the non-linear fit by reconstructing the metrology data from the compressed form and ensuring it is substantially similar to the input metrology data. Machine learning model 190A may include an artificial neural network. In some embodiments, model 190A may further include a deep learning network. Machine learning model 190A may include one or more of a convolutional neural network model, a deep belief network, a feedforward neural network, a multilayer neural network, an autoencoder, and/or the like.

Historical metrology data 162 may be used as input to trained machine learning model 190A. The output compressed historical metrology data (historical compressed data) may then be used by other components of system 100, e.g. to train second machine learning model 190B. Current metrology data 164 may be used as input to trained machine learning model 190A. The output compressed metrology data may then be used in other components of system 100, e.g. as input into a second trained machine learning model, model 190B. Trained machine learning model 190A may also take as input compressed metrology data, e.g. from second trained machine learning model 190B. Trained machine learning model 190A may then reconstruct metrology data substantially accurately from the compressed data given as input to trained machine learning model 190A.

Dimensional reduction of metrology data 160 has significant technical advantages compared to working with full metrology data sets. Metrology data 160 of a single substrate can constitute a large amount of data, possibly many thousands of data points, and can be costly to work with in terms of computational time and energy, bandwidth to transmit the metrology data 160, etc. Training a machine learning model with metrology data 160 as target output data, e.g. machine learning model 190B, can suffer particularly from large metrology data sets. In order for machine learning model 190B to have useful predictive accuracy of a large set of data points of a substrate, a large number of training substrates are to be used to train the model. Performing metrology can be costly in terms of time used, metrology equipment 128 used, energy consumed, computation expense to process the data, etc. To train machine learning model 190B with compressed data 166 (e.g., a dimensionally reduced compressed data set) as target output can use significantly fewer substrates to obtain acceptable predictive power, less energy consumed, less processor overhead, and less bandwidth used, which cuts down on these costs.

It will be understood that in some embodiments, the type of data being provided to models 190 may be changed, and still be within the scope of this disclosure. In some embodiments, sensor data 142 or manufacturing parameters 150 may be provided to trained machine learning model 190A for dimensional reduction to generate compressed data 166 (e.g., compressed sensor data, compressed manufacturing data). In some embodiments, data indicative of metrology data 160 may be provided as input to trained machine learning model 190B, and data indicative of sensor data 142 or manufacturing parameters 150 predicted to produce the input metrology data 160 input may be output. Either the input metrology data 160, output sensor data 142 or manufacturing parameters 150, or both may be in a compressed form (e.g., compressed by trained machine learning model 190A).

In some embodiments, the predictive component 114 receives current sensor data 146 and/or current manufacturing parameters 154, performs signal processing to break down the current data into sets of current data, provides the sets of current data as input to a trained machine learning model 190B, and obtains outputs indicative of predictive data 168 from the trained machine learning model 190B. In some embodiments, the predictive data is indicative of metrology data (e.g., prediction of current metrology data 164), expressed in a compressed form. In some embodiments, the compressed data may be sent to a second machine learning model 190A. Machine learning model 190A, in some embodiments, may reconstruct full metrology data (e.g., reconstructed data 169) from the compressed data.

In some embodiments, the predictive component 114 receives current sensor data 146 and/or current manufacturing parameters 154, and may perform pre-processing such as extracting a pattern in the data or combining data to new composite data. Predictive component 114 may then provide the data to trained machine learning model 190B as input. Predictive component 114 may receive from trained machine learning model 190B predicted metrology data, expressed in compressed form. Predictive component 114 may then provide the compressed data to trained machine learning model 190A, which then reconstructs substrate metrology data by dimensionally expanding the compressed data using a non-linear fit. Predictive component 114 may then receive the predicted metrology data (e.g., reconstructed data 169) as output from machine learning model 190A.

In some embodiments the trained machine learning model 190A and the trained machine learning model 190B may be separate models. In some embodiments, the trained machine learning model 190A and the trained machine learning model 190B may be the same model 190 (e.g., an ensemble model). The predictive component 114 may receive current sensor data 146 and/or current manufacturing parameters 154, provide the data to a trained machine learning model 190 (e.g., an ensemble model), and obtain outputs indicative of predictive data 168 from the trained machine learning model 190.

In some embodiments, trained machine learning model 190A may be trained using historical metrology data 162. In some embodiments, trained machine learning model 190B may be trained using historical sensor data 144, historical manufacturing parameters 152, and historical metrology data 162, expressed in a compressed form by trained machine learning model 190A. It will be understood that other combinations of data, such as training machine learning model 190A to compress historical sensor data 144 and/or historical manufacturing parameters 152, and using historical metrology data 162 and compressed data from trained machine learning model 190A to train machine learning model 190B, are within the scope of this disclosure. A combined trained machine learning model 190 (e.g., an ensemble model) may be trained using historical metrology data 162, historical sensor data 144, and/or historical manufacturing parameters 152.

Data store 140 may be a memory (e.g., random access memory), a drive (e.g., a hard drive, a flash drive), a database system, or another type of component or device capable of storing data. Data store 140 may include multiple storage components (e.g., multiple drives or multiple databases) that may span multiple computing devices (e.g., multiple server computers). The data store 140 may store sensor data 142, manufacturing parameters 150, metrology data 160, compressed data 166, and predictive data 168. Sensor data 142 may include historical sensor data 144 and current sensor data 146. Sensor data may include sensor data time traces over the duration of manufacturing processes, associations of data with physical sensors, pre-processed data, such as averages and composite data, and data indicative of sensor performance over time (i.e., many manufacturing processes). Manufacturing parameters 150 and metrology data 160 may contain similar features. Historical sensor data 144, historical manufacturing parameters 152, and historical metrology data 162 may be historical data (e.g., at least a portion for training the machine learning models 190). The current sensor data 146 may be current data (e.g., at least a portion to be input into the trained machine learning models 190, subsequent to the historical data) for which predictive data 168 is to be generated (e.g., for performing corrective actions). Compressed data 166 may include any of the above types of data, such as sensor, manufacturing, and metrology data, as both historical and current data, expressed in compressed form. Compressed data 166 may have been compressed from sensor data 142, manufacturing parameters 150, or metrology data 160 by trained machine learning model 190A.

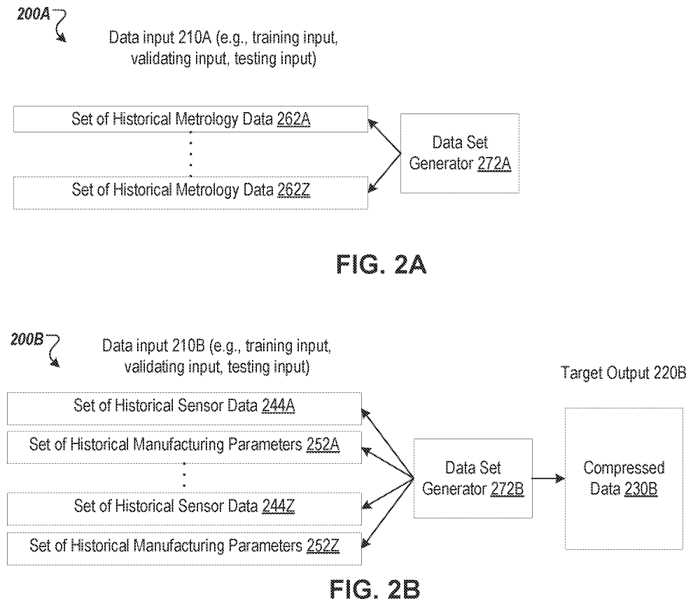

In some embodiments, predictive system 110 further includes server machine 170 and server machine 180. Server machine 170 includes a data set generator 172 that is capable of generating data sets (e.g., a set of data inputs and a set of target outputs) to train, validate, and/or test machine learning model(s) 190. Some operations of data set generator 172 are described in detail below with respect to FIGS. 2A-B and 4A. In some embodiments, the data set generator 172 may partition the historical data (e.g., historical sensor data 144, historical manufacturing parameters 152, historical metrology data 162, or compressed versions thereof stored in data store 140 as compressed data 166) into a training set (e.g., sixty percent of the historical data), a validating set (e.g., twenty percent of the historical data), and a testing set (e.g., twenty percent of the historical data). In some embodiments, the predictive system 110 (e.g., via predictive component 114) generates multiple sets of features. For example a first set of features may correspond to a first set of types of sensor data (e.g., from a first set of sensors, first combination of values from first set of sensors, first patterns in the values from the first set of sensors) that correspond to each of the data sets (e.g., training set, validation set, and testing set) and a second set of features may correspond to a second set of types of sensor data (e.g., from a second set of sensors different from the first set of sensors, second combination of values different from the first combination, second patterns different from the first patterns) that correspond to each of the data sets.

Server machine 180 includes a training engine 182, a validation engine 184, selection engine 185, and/or a testing engine 186. An engine (e.g., training engine 182, a validation engine 184, selection engine 185, and a testing engine 186) may refer to hardware (e.g., circuitry, dedicated logic, programmable logic, microcode, processing device, etc.), software (such as instructions run on a processing device, a general purpose computer system, or a dedicated machine), firmware, microcode, or a combination thereof. The training engine 182 may be capable of training a machine learning model 190 using one or more sets of features associated with the training set from data set generator 172. The training engine 182 may generate multiple trained machine learning models 190, where each trained machine learning model 190 corresponds to a distinct set of features of the training set (e.g., sensor data from a distinct set of sensors). For example, a first trained machine learning model may have been trained using all features (e.g., X1-X5), a second trained machine learning model may have been trained using a first subset of the features (e.g., X1, X2, X4), and a third trained machine learning model may have been trained using a second subset of the features (e.g., X1, X3, X4, and X5) that may partially overlap the first subset of features. Data set generator 172 may receive the output of a trained machine learning model (e.g., 190A), collect that data into training, validation, and testing data sets, and use the data sets to train a second machine learning model (e.g., 190B).

The validation engine 184 may be capable of validating a trained machine learning model 190 using a corresponding set of features of the validation set from data set generator 172. For example, a first trained machine learning model 190 that was trained using a first set of features of the training set may be validated using the first set of features of the validation set. The validation engine 184 may determine an accuracy of each of the trained machine learning models 190 based on the corresponding sets of features of the validation set. The validation engine 184 may discard trained machine learning models 190 that have an accuracy that does not meet a threshold accuracy. In some embodiments, the selection engine 185 may be capable of selecting one or more trained machine learning models 190 that have an accuracy that meets a threshold accuracy. In some embodiments, the selection engine 185 may be capable of selecting the trained machine learning model 190 that has the highest accuracy of the trained machine learning models 190.

The testing engine 186 may be capable of testing a trained machine learning model 190 using a corresponding set of features of a testing set from data set generator 172. For example, a first trained machine learning model 190 that was trained using a first set of features of the training set may be tested using the first set of features of the testing set. The testing engine 186 may determine a trained machine learning model 190 that has the highest accuracy of all of the trained machine learning models based on the testing sets.

The machine learning model 190 may refer to the model artifact that is created by the training engine 182 using a training set that includes data inputs and corresponding target outputs (correct answers for respective training inputs). Patterns in the data sets can be found that map the data input to the target output (the correct answer), and the machine learning model 190 is provided mappings that captures these patterns. The machine learning model 190 may use one or more of Support Vector Machine (SVM), Radial Basis Function (RBF), clustering, supervised machine learning, semi-supervised machine learning, unsupervised machine learning, k-Nearest Neighbor algorithm (k-NN), linear regression, random forest, neural network (e.g., artificial neural network), etc.

Predictive component 114 may provide current sensor data 146 to the trained machine learning model 190 and may run the trained machine learning model 190 on the input to obtain one or more outputs. The predictive component 114 may be capable of determining (e.g., extracting) predictive data 168 from the output of the trained machine learning model 190 and may determine (e.g., extract) confidence data from the output that indicates a level of confidence that the predictive data 168 is an accurate predictor of a process associated with the input data for products produced or to be produced using the manufacturing equipment 124 at the current sensor data 146 and/or current manufacturing parameters 154. The predictive component 114 or corrective action component 122 may use the confidence data to decide whether to cause a corrective action associated with the manufacturing equipment 124 based on the predictive data 168.

The confidence data may include or indicate a level of confidence that the predictive data 168 is an accurate prediction for products associated with at least a portion of the input data. In one example, the level of confidence is a real number between 0 and 1 inclusive, where 0 indicates no confidence that the predictive data 168 is an accurate prediction for products processed according to input data and 1 indicates absolute confidence that the predictive data 168 accurately predicts properties of products processed according to input data. In some embodiments, the input data may instead be metrology data, the output predicted sensor data and/or manufacturing parameters, and confidence data a level of confidence that a product with properties of the input data would result from processing associated with the output data. Responsive to the confidence data indicating a level of confidence below a threshold level for a predetermined number of instances (e.g., percentage of instances, frequency of instances, total number of instances, etc.) the predictive component 114 may cause the trained machine learning model 190 to be re-trained (e.g., based on current sensor data 146, current manufacturing parameters 154, current metrology data 164, etc.).

For purpose of illustration, rather than limitation, aspects of the disclosure describe the training of one or more machine learning models 190 using historical data (e.g., historical sensor data 144, historical manufacturing parameters 152, and historical metrology data 162) and inputting current data (e.g., current sensor data 146, current manufacturing parameters 154, and current metrology data 164) into the one or more trained machine learning models 190 to determine predictive data 168. In other embodiments, a heuristic model or rule-based model is used to determine predictive data 168 (e.g., without using a trained machine learning model). The input to this rule-based model may be compressed data, compressed by trained machine learning model 190A. Predictive component 114 may monitor historical sensor data 144, historical manufacturing parameters 152, and historical metrology data 162. Any of the information described with respect to data inputs 210 of FIGS. 2A-B may be monitored or otherwise used in the heuristic or rule-based model.

In some embodiments, the functions of client device 120, predictive server 112, server machine 170, and server machine 180 may be provided by a fewer number of machines. For example, in some embodiments server machines 170 and 180 may be integrated into a single machine, while in some other embodiments, server machine 170, server machine 180, and predictive server 112 may be integrated into a single machine. In some embodiments, client device 120 and predictive server 112 may be integrated into a single machine.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 may determine the corrective action based on the predictive data 168. In another example, client device 120 may determine the predictive data 168 based on output from the trained machine learning model.

In addition, the functions of a particular component can be performed by different or multiple components operating together. One or more of the predictive server 112, server machine 170, or server machine 180 may be accessed as a service provided to other systems or devices through appropriate application programming interfaces (API).

In embodiments, a “user” may be represented as a single individual. However, other embodiments of the disclosure encompass a “user” being an entity controlled by a plurality of users and/or an automated source. For example, a set of individual users federated as a group of administrators may be considered a “user.”

Embodiments of the disclosure may be applied to data quality evaluation, feature enhancement, model evaluation, Virtual Metrology (VM), Predictive Maintenance (PdM), limit optimization, or the like.

Although embodiments of the disclosure are discussed in terms of generating predictive data 168 to perform a corrective action in manufacturing facilities (e.g., semiconductor manufacturing facilities), embodiments may also be generally applied to improved data processing by dimensionally reducing data to a compressed form using a trained machine learning model. Embodiments may be generally applied to characterizing and monitoring based on different types of data.

FIGS. 2A-B are one or more example data set generators 272 (e.g., data set generator 172 of FIG. 1) to create data sets for a machine learning model (e.g., model 190 of FIG. 1), according to certain embodiments. Each data set generator 272 may be part of server machine 170 of FIG. 1. In some embodiments, data set generator 272 both of FIGS. 2A-B are the same data set generator. In some embodiments, data set generator from each of FIGS. 2A-B is a separate data set generator.

Referring to FIG. 2A, system 200A containing data set generator 272A (e.g., data set generator 172 of FIG. 1) creates data sets for a machine learning model (e.g., model 190A of FIG. 1). Data set generator 272A may create data sets using historical metrology data 262 (e.g., historical metrology data 162 of FIG. 1). System 200A may be used to generate data sets to train, test, and validate an unsupervised machine learning model (e.g., machine learning model 190A of FIG. 1). The machine learning model, in some embodiments, is not supplied with a target output data set as in supervised machine learning. The machine learning model may be trained to manipulate the input data according to some fit, and then reverse the fit to reconstruct data substantially similar to the input data. The manipulation of the data may be a dimensional reduction, converting the input data to a compressed form. The fit used for dimensional reduction may be a non-linear fit. System 200A of FIG. 2A shows data set generator 272A and data inputs 210A.

Referring to FIG. 2B, system 200B containing data set generator 272B (e.g., data set generator 172 of FIG. 1) creates data sets for a machine learning model (e.g., model 190B of FIG. 1). Data set generator 272B may create data sets using historical sensor data 244 and historical manufacturing parameters 252. These data sets may be supplied to a machine learning model, e.g. model 190B of FIG. 1, as training input. Data set generator 272B may also provide compressed metrology data to the machine learning model during training as target output. The compressed metrology data may be indicative of historical metrology data (e.g., historical metrology data 162 of FIG. 1) compressed by a trained machine learning model (e.g., model 190A of FIG. 1).

It is within the scope of this disclosure for different combinations of data to be compressed, and to be used as training input and target variables in the various machine learning models disclosed herein. For instance, a machine learning model may be trained on historic metrology data to produce as an output manufacturing parameters that is predicted to result in production of a subsequent substrate, the properties of which match the input metrology data, with the manufacturing parameters or the metrology data being in compressed form, and still be within the scope of this disclosure.

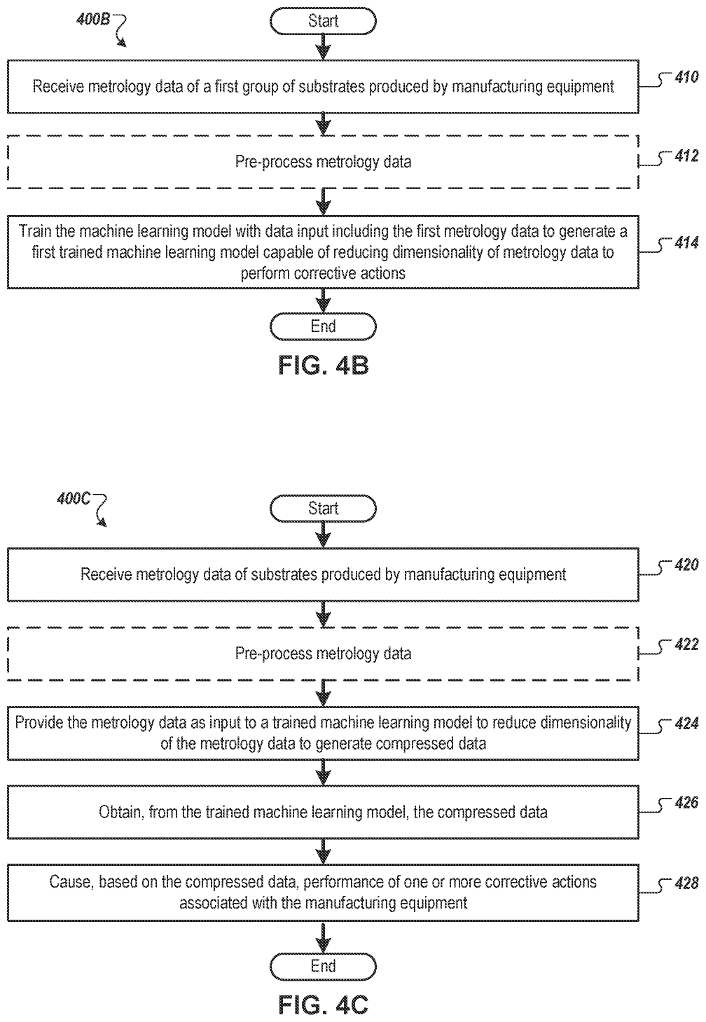

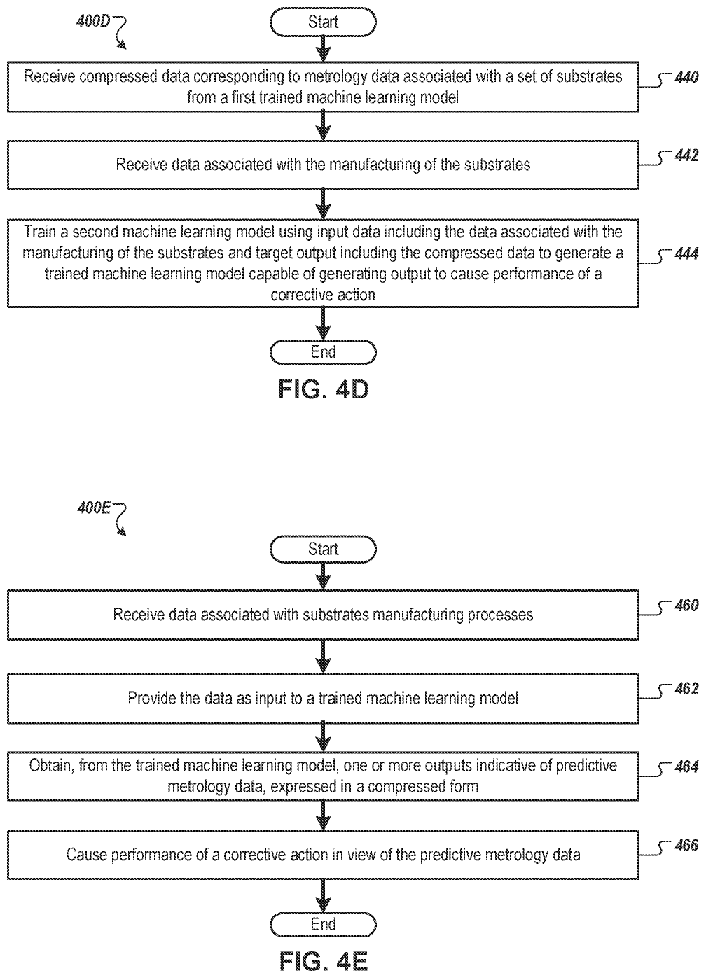

Referring to FIGS. 2A-B, in some embodiments, data set generator 272 generates a data set (e.g., training set, validating set, testing set) that includes one or more data inputs 210 (e.g., training input, validating input, testing input) and may include one or more target outputs 220 that correspond to the data inputs 210. The data set may also include mapping data that maps the data inputs 210 to the target outputs 220. Data inputs 210 may also be referred to as “features,” “attributes,” or “information.” In some embodiments, data set generator 272 may provide the data set to the training engine 182, validating engine 184, or testing engine 186, where the data set is used to train, validate, or test the machine learning model 190. Some embodiments of generating a training set may further be described with respect to FIG. 4B.

In some embodiments, data set generator 272 generates data input 210 and does not generate target output 220 (e.g., data set generator 272A generating sets of historical metrology data 262A-262Z as data input 210A), to supply to an unsupervised machine learning model. In some embodiments, data set generator 272 generates the data input 210 and target output 220 (e.g., data set generator 272B generating sets of historical sensor data 244A-244Z and sets of historical manufacturing parameters 252A-252Z as data input 210B, and compressed data 230B as target output 220B). In some embodiments, data inputs 210 may include one or more sets of historical sensor data 244 or historical manufacturing parameters 252. Each instance of historical sensor data 244 or historical manufacturing parameters 252 may include one or more of sensor data from one or more types of sensors, combination of sensor data from one or more types of sensors, patterns from sensor data from one or more types of sensors, manufacturing parameters from one or more manufacturing parameters, combinations of some manufacturing parameter data and some sensor data, etc.

In some embodiments, data set generator 272 may generate a first data input corresponding to a first set of historical sensor data 244A and/or historical manufacturing parameters 252A to train, validate, or test a first machine learning model and the data set generator 272 may generate a second data input corresponding to a second set of historical sensor data 244B and/or historical manufacturing parameters 252B to train, validate, or test a second machine learning model.

In some embodiments, the data set generator 272 may discretize (e.g., segment) one or more of the data input 210 or the target output 220 (e.g., to use in classification algorithms for regression problems). Discretization (e.g., segmentation via a sliding window) of the data input 210 or target output 220 may transform continuous values of variables into discrete values. In some embodiments, the discrete values for the data input 210 indicate discrete historical sensor data 244 to obtain a target output 220 (e.g., discrete compressed data 230B).

Data inputs 210 and target outputs 220 to train, validate, or test a machine learning model may include information for a particular facility (e.g., for a particular semiconductor manufacturing facility). For example, the historical sensor data 244 and compressed data 230B may be for the same manufacturing facility. In another example, historical manufacturing parameters 252 and compressed data 230B may be for the same manufacturing facility.

In some embodiments, the information used to train the machine learning model may be from specific types of manufacturing equipment (e.g., manufacturing equipment 124 of FIG. 1) of the manufacturing facility having specific characteristics and allow the trained machine learning model to determine outcomes for a specific group of manufacturing equipment 124 based on input for current sensor data (e.g., current sensor data 146) associated with one or more components sharing characteristics of the specific group. In some embodiments, the information used to train the machine learning model may be for components from two or more manufacturing facilities and may allow the trained machine learning model to determine outcomes for components based on input from one manufacturing facility.

In some embodiments, subsequent to generating a data set and training, validating, or testing a machine learning model 190 using the data set, the machine learning model 190 may be further trained, validated, or tested, or adjusted (e.g., adjusting weights associated with input data of the machine learning model 190, such as connection weights in a neural network).

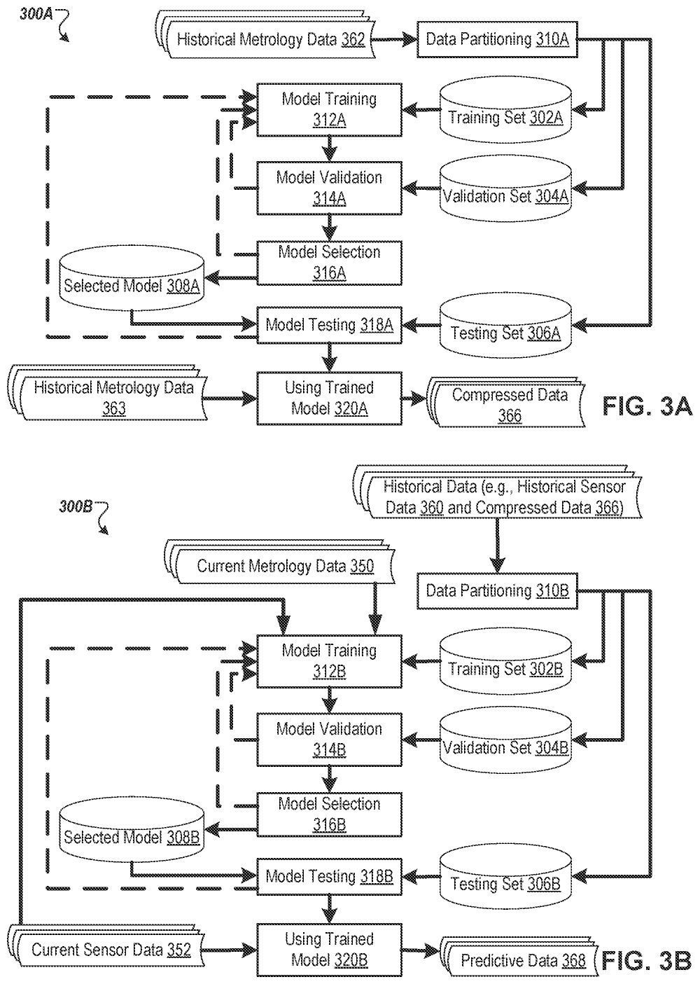

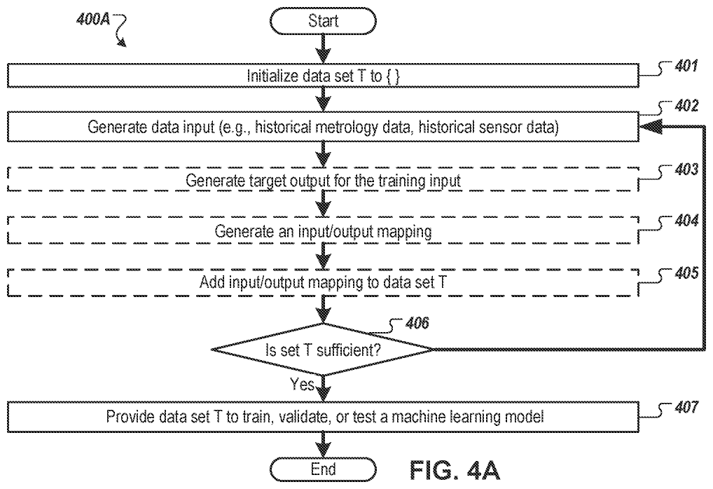

FIGS. 3A-B are block diagrams illustrating systems 300 for generating output data (e.g., predictive data 168 of FIG. 1), according to certain embodiments. The systems 300 may be used compress input data to a form of reduced dimensionality (e.g., model 190A of FIG. 1) and/or to determine a corrective action associated with manufacturing equipment 124 based on the predictive data 368 (e.g., model 190B of FIG. 1).

Referring to FIG. 3A, at block 310A, the system 300A (e.g., components of predictive system 110 of FIG. 1) performs data partitioning (e.g., via data set generator 172 of server machine 170 of FIG. 1) of the historical data (e.g., historical metrology data 362 for model 190A of FIG. 1) to generate the training set 302A, validation set 304A, and testing set 306A. For example, the training set may be 60% of the historical data, the validation set may be 20% of the historical data, and the testing set may be 20% of the historical data.

At block 312A, the system 300A performs model training (e.g., via training engine 182 of FIG. 1) using the training set 302A. The system 300A may train multiple models using multiple sets of features of the training set 302A (e.g., a first set of features of the training set 302A, a second set of features of the training set 302A, etc.). For example, system 300 may train a machine learning model to generate a first trained machine learning model using the first set of features in the training set (e.g., a subset of the metrology data for a subset of substrates) and to generate a second trained machine learning model using the second set of features in the training set (e.g., different data than the data used to train the first machine learning model, different in terms of data selection, substrate selection, or both). In some embodiments, the first trained machine learning model and the second trained machine learning model may be combined to generate a third trained machine learning model (e.g., which may be a better predictor than the first or the second trained machine learning model on its own). In some embodiments, sets of features used in comparing models may overlap (e.g., one model may be trained with a set of substrates that has some substrates in common with the set used to train the other model). In some embodiments, hundreds of models may be generated including models with various permutations of features and combinations of models.

At block 314A, the system 300A performs model validation (e.g., via validation engine 184 of FIG. 1) using the validation set 304A. The system 300A may validate each of the trained models using a corresponding set of features of the validation set 304A. For instance, validation set 304A may use the same subset of metrology data used to train a machine learning model, but for a different set of substrates. The subset of metrology data could be a type of metrology data, a subset of data points, different pre-processing methods, etc. In some embodiments, the system 300A may validate hundreds of models (e.g., models with various permutations of features, combinations of models, etc.) generated at block 312A. At block 314A, the system 300A may determine an accuracy of each of the one or more trained models (e.g., via model validation) and may determine whether one or more of the trained models has an accuracy that meets a threshold accuracy. Responsive to determining that none of the trained models has an accuracy that meets a threshold accuracy, flow returns to block 312A where the system 300A performs model training using different sets of features of the training set. Responsive to determining that one or more of the trained models has an accuracy that meets a threshold accuracy, flow continues to block 316A. The system 300A may discard the trained machine learning models that have an accuracy that is below the threshold accuracy (e.g., based on the validation set).

At block 316A, the system 300A performs model selection (e.g., via selection engine 185 of FIG. 1) to determine which of the one or more trained models that meet the threshold accuracy has the highest accuracy (e.g., the selected model 308A, based on the validating of block 314A). Responsive to determining that two or more of the trained models that meet the threshold accuracy have the same accuracy, flow may return to block 312A where the system 300A performs model training using further refined training sets corresponding to further refined sets of features for determining a trained model that has the highest accuracy.

At block 318A, the system 300A performs model testing (e.g., via testing engine 186 of FIG. 1) using the testing set 306A to test the selected model 308A. The system 300A may test, using the first set of features in the testing set (e.g., the same subset of metrology features for a third set of substrates), the first trained machine learning model to determine the first trained machine learning model meets a threshold accuracy (e.g., based on the first set of features of the testing set 306A). Responsive to accuracy of the selected model 308A not meeting the threshold accuracy (e.g., the selected model 308A is overly fit to the training set 302A and/or validation set 304A and is not applicable to other data sets such as the testing set 306A), flow continues to block 312A where the system 300A performs model training (e.g., retraining) using different training sets possibly corresponding to different sets of features or a reorganization of substrates split into training, validation, and testing sets. Responsive to determining that the selected model 308A has an accuracy that meets a threshold accuracy based on the testing set 306A, flow continues to block 320A. In at least block 312A, the model may learn patterns in the historical data to make predictions and in block 318A, the system 300A may apply the model on the remaining data (e.g., testing set 306A) to test the predictions.

At block 320A, system 300A uses the trained model (e.g., selected model 308A) to receive historical metrology data 363 (e.g., historical metrology data 162 of FIG. 1) and determines (e.g., extracts), from the output of the trained model, compressed data 366 (e.g., predictive data 168 of FIG. 1) to perform an action (e.g., perform a corrective action in association with manufacturing equipment 124 of FIG. 1 in view of compressed data 366, provide compressed data 366 to another model, potentially a machine learning model, etc.). In some embodiments, historical metrology data 363 used as input to the trained machine learning model may be the same as historical metrology data 362 used to train the machine learning model. In some embodiments, the sets of historical metrology data may overlap, or have no data in common. In some embodiments, only a subset of the metrology data may be used as input to the trained machine learning model. The subset of data may correspond to the subset of data used to train the machine learning model.

Referring to FIG. 3B, at block 310B, the system 300B (e.g., components of predictive system 110 of FIG. 1) performs data partitioning (e.g., via data set generator 172 of server machine 170 of FIG. 1) of the historical data (e.g., historical sensor data 360 and compressed data 366 indicative of metrology data of substrates for model 190B of FIG. 1) to generate the training set 302B, validation set 304B, and testing set 306B. It will be understood that, for the purpose of concise representation, embodiments with only this combination of data are shown and discussed in connection with FIG. 3B, but other combinations are possible and within the scope of this disclosure. For instance, manufacturing parameters may be used instead of or in conjunction with sensor data, the use of sensor data as input and compressed metrology data as output could be reversed, and more or different categories of data may be in a compressed form.

The generation of training set 302B, validation set 304B, and testing set 306B can be tailored for a particular application. For example, the training set may be 60% of the historical data, the validation set may be 20% of the historical data, and the testing set may be 20% of the historical data. System 300B may generate a plurality of sets of features for each of the training set, the validation set, and the testing set. For example, if the historical data includes features derived from sensor data from 20 sensors (e.g., sensors 126 of FIG. 1) and 100 products (e.g., products that each correspond to the sensor data from the 20 sensors), a first set of features may be sensors 1-10, a second set of features may be sensors 11-20, the training set may be products 1-60, the validation set may be products 61-80, and the testing set may be products 81-100. In this example, the first set of features of the training set would be sensor data from sensors 1-10 for products 1-60.

At block 312B, the system 300B performs model training (e.g., via training engine 182 of FIG. 1) using the training set 302B. The system 300B may train multiple models using multiple sets of features of the training set 302B (e.g., a first set of features of the training set 302B, a second set of features of the training set 302B, etc.). For example, system 300B may train a machine learning model to generate a first trained machine learning model using the first set of features in the training set (e.g., sensor data from sensors 1-10 for products 1-60) and to generate a second trained machine learning model using the second set of features in the training set (e.g., sensor data from sensors 11-20 for products 1-60). In some embodiments, the first trained machine learning model and the second trained machine learning model may be combined to generate a third trained machine learning model (e.g., which may be a better predictor than the first or the second trained machine learning model on its own). In some embodiments, sets of features used in comparing models may overlap (e.g., first set of features being sensor data from sensors 1-15 and second set of features being sensors 5-20). In some embodiments, hundreds of models may be generated including models with various permutations of features and combinations of models.

At block 314B, the system 300B performs model validation (e.g., via validation engine 184 of FIG. 1) using the validation set 304B. The system 300B may validate each of the trained models using a corresponding set of features of the validation set 304B. For example, system 300B may validate the first trained machine learning model using the first set of features in the validation set (e.g., sensor data from sensors 1-10 for products 61-80) and the second trained machine learning model using the second set of features in the validation set (e.g., sensor data from sensors 11-20 for products 61-80). In some embodiments, the system 300B may validate hundreds of models (e.g., models with various permutations of features, combinations of models, etc.) generated at block 312B. At block 314B, the system 300B may determine an accuracy of each of the one or more trained models (e.g., via model validation) and may determine whether one or more of the trained models has an accuracy that meets a threshold accuracy. Responsive to determining that none of the trained models has an accuracy that meets a threshold accuracy, flow returns to block 312B where the system 300B performs model training using different sets of features of the training set. Responsive to determining that one or more of the trained models has an accuracy that meets a threshold accuracy, flow continues to block 316B. The system 300B may discard the trained machine learning models that have an accuracy that is below the threshold accuracy (e.g., based on the validation set).

At block 316B, the system 300B performs model selection (e.g., via selection engine 185 of FIG. 1) to determine which of the one or more trained models that meet the threshold accuracy has the highest accuracy (e.g., the selected model 308B, based on the validating of block 314B). Responsive to determining that two or more of the trained models that meet the threshold accuracy have the same accuracy, flow may return to block 312B where the system 300B performs model training using further refined training sets corresponding to further refined sets of features for determining a trained model that has the highest accuracy.

At block 318B, the system 300B performs model testing (e.g., via testing engine 186 of FIG. 1) using the testing set 306B to test the selected model 308B. The system 300B may test, using the first set of features in the testing set (e.g., sensor data from sensors 1-10 for products 81-100), the first trained machine learning model to determine the first trained machine learning model meets a threshold accuracy (e.g., based on the first set of features of the testing set 306B). Responsive to accuracy of the selected model 308B not meeting the threshold accuracy (e.g., the selected model 308B is overly fit to the training set 302B and/or validation set 304B and is not applicable to other data sets such as the testing set 306B), flow continues to block 312B where the system 300B performs model training (e.g., retraining) using different training sets corresponding to different sets of features (e.g., sensor data from different sensors). Responsive to determining that the selected model 308B has an accuracy that meets a threshold accuracy based on the testing set 306B, flow continues to block 320B. In at least block 312B, the model may learn patterns in the historical data to make predictions and in block 318B, the system 300B may apply the model on the remaining data (e.g., testing set 306B) to test the predictions.

At block 320B, system 300B uses the trained model (e.g., selected model 308B) to receive current sensor data 352 (e.g., current sensor data 146 of FIG. 1) and determines (e.g., extracts), from the output of the trained model, predictive data 368 (e.g., predictive data 168 of FIG. 1) to perform signal processing or to perform corrective actions associated with the manufacturing equipment 124. In some embodiments, the current sensor data 352 may correspond to the same types of features in the historical sensor data. In some embodiments, the current sensor data 352 corresponds to a same type of features as a subset of the types of features in historical sensor data that are used to train the selected model 308B.

In some embodiments, current data is received. Current data may include current sensor data 352 (e.g., current sensor data 146 of FIG. 1) and/or current metrology data 350. It will be understood, as discussed above in connection with FIG. 3A, that pictured and discussed is one exemplary embodiment of how data can be processed, but other data combinations are possible and within the scope of this disclosure. Measured metrology data, e.g. current metrology data 350, may also be input to model training at block 312B along with current sensor data 352. The model 308B is re-trained based on the current data. In some embodiments, a new model is trained based on the current metrology data 350 and the current sensor data 352.

In some embodiments, one or more of the acts 310-320 may occur in various orders and/or with other acts not presented and described herein. In some embodiments, one or more of acts 310-320 may not be performed. For example, in some embodiments, one or more of data partitioning of block 310, model validation of block 314, model selection of block 316, or model testing of block 318 may not be performed.

FIGS. 4A-E are flow diagrams of methods 400A-E associated with generating predictive data to cause a corrective action, according to certain embodiments. Methods 400A-E may be performed by processing logic that may include hardware (e.g., circuitry, dedicated logic, programmable logic, microcode, processing device, etc.), software (such as instructions run on a processing device, a general purpose computer system, or a dedicated machine), firmware, microcode, or a combination thereof. In some embodiment, methods 400A-E may be performed, in part, by predictive system 110. Method 400A may be performed, in part, by predictive system 110 (e.g., server machine 170 and data set generator 172 of FIG. 1, data set generator 272 of FIG. 2A-B). Predictive system 110 may use method 400A to generate a data set to at least one of train, validate, or test a machine learning model, in accordance with embodiments of the disclosure. Methods 400B and 400D may be performed by server machine 180 (e.g., training engine 182, etc.). Methods 400C and 400E may be performed by predictive server 112 (e.g., predictive component 114). In some embodiments, a non-transitory storage medium stores instructions that when executed by a processing device (e.g., of predictive system 110, of server machine 180, of predictive server 112, etc.) cause the processing device to perform one or more of methods 400A-E.

For simplicity of explanation, methods 400A-E are depicted and described as a series of operations. However, operations in accordance with this disclosure can occur in various orders and/or concurrently and with other operations not presented and described herein. Furthermore, not all illustrated operations may be performed to implement methods 400A-E in accordance with the disclosed subject matter. In addition, those skilled in the art will understand and appreciate that methods 400A-E could alternatively be represented as a series of interrelated states via a state diagram or events.

FIG. 4A is a flow diagram of a method 400A for generating a data set for a machine learning model for generating predictive data (e.g., predictive data 168 of FIG. 1), according to certain embodiments.

Referring to FIG. 4A, in some embodiments, at block 401 the processing logic implementing method 400A initializes a training set T to an empty set.

At block 402, processing logic generates first data input (e.g., first training input, first validating input) that may include one or more of sensor data (e.g., historical sensor data 144 of FIG. 1, historical sensor data 244 of FIG. 2B), metrology data (e.g., historical metrology data 162 of FIG. 1), manufacturing parameters (e.g., historical manufacturing parameters 152 of FIG. 1), etc. In some embodiments, the first data input may include a first set of features for types of data and a second data input may include a second set of features for types of data (e.g., as described with respect to FIG. 3B).

In some embodiments, at block 403, processing logic generates a first target output for one or more of the data inputs (e.g., first data input). In some embodiments, the first target output is metrology data (e.g., historical metrology data 162 or compressed data 166 of FIG. 1) (e.g., for model 190B). In some embodiments, no target output is generated (e.g., an unsupervised machine learning model capable of reducing dimensionality of input data to a compressed form may reconstruct full dimensional data and compare the reconstructed data to the input data, rather than requiring target output to be provided).

At block 404, processing logic optionally generates mapping data that is indicative of an input/output mapping. The input/output mapping (or mapping data) may refer to the data input (e.g., one or more of the data inputs described herein), the target output for the data input, and an association between the data input(s) and the target output. In some embodiments, such as in association with machine learning models where no target output is provided, block 404 may not be executed.

At block 405, processing logic adds the mapping data generated at block 404 to data set T, in some embodiments.

At block 406, processing logic branches based on whether data set T is sufficient for at least one of training, validating, and/or testing machine learning model 190. If so, execution proceeds to block 407, otherwise, execution continues back at block 402. It should be noted that in some embodiments, the sufficiency of data set T may be determined based simply on the number of inputs, mapped in some embodiments to outputs, in the data set, while in some other embodiments, the sufficiency of data set T may be determined based on one or more other criteria (e.g., a measure of diversity of the data examples, accuracy, etc.) in addition to, or instead of, the number of inputs.

At block 407, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 210) are input to the neural network, and output values (e.g., numerical values associated with target outputs 220) of the input/output mapping are stored in the output nodes of the neural network. The connection weights in the neural network are then adjusted in accordance with a learning algorithm (e.g., back propagation, etc.), and the procedure is repeated for the other input/output mappings in data set T. After block 407, machine learning model (e.g., machine learning model 190) can be at least one of trained using training engine 182 of server machine 180, validated using validating engine 184 of server machine 180, or tested using testing engine 186 of server machine 180. The trained machine learning model may be implemented by predictive component 114 (of predictive server 112) to generate predictive data 168 for performing signal processing or for performing corrective action associated with the manufacturing equipment 124.

FIG. 4B is a method 400B for training a machine learning model (e.g., model 190A of FIG. 1) to dimensionally reduce data to a compressed form.

Referring to FIG. 4B, at block 410 of method 400B, the processing logic receives metrology data (e.g., historical metrology data) associated with producing, by manufacturing equipment, products (e.g., substrates).

At block 412, the processing logic may perform pre-processing on the metrology data. Pre-processed metrology data may include choosing a subset of available metrology data, determining fits of the data, making combinations of available data, or the like. Metrology data may include thickness data, in-plane displacement data, chemical data, optical data, or any other metrology data associated with the substrate.

At block 414, the processing logic trains a machine learning model using data input including the metrology data (e.g., historical metrology data, pre-processed metrology data) to generate a trained machine learning model. The trained machine learning model may be capable of reducing dimensionality of metrology data (e.g., generating outputs indicative of the input metrology data, expressed in a compressed form) to perform corrective actions. The machine learning model may use non-linear fits to compress the metrology data. The machine learning model may be an unsupervised model, with no provided target output. Instead, the machine learning model may accept historical metrology data as input and perform a non-linear fit to compress the data to a compressed form with reduced dimensionality. Then, the machine learning model may reconstruct the metrology data from the compressed data. The machine learning model may then compare the reconstructed data to the input metrology data, and determine the accuracy of the model (e.g., using validation engine 184 of FIG. 1) based on how faithfully the metrology data is recreated from the compressed data (e.g., recreated metrology data is within 1%, 5%, 10%, 20% of actual metrology data). The training of the machine learning model may use any type or combination of types of metrology data associated with manufacturing (e.g., using any type or combinations of types of manufacturing equipment, such as manufacturing equipment 124 of FIG. 1) of any type or combination of types of produced substrates. In some embodiments, the machine learning model may be trained on thickness data of all available substrates of a certain design, produced on any compatible manufacturing equipment. The machine learning model may then be used to compress thickness metrology data of any subsequent substrates of the same design, produced on any type (e.g., new types) of manufacturing equipment. Many such combinations of data type, substrates, manufacturing equipment design, physical equipment components, and the like are possible, and can be chosen to optimize a particular use case. In some embodiments, the machine learning model is trained using metrology data of normal (e.g., non-defective) products (e.g., substrates). In some embodiments, the machine learning model is trained using metrology data of normal and abnormal products.

FIG. 4C is a method 400C for using a machine learning model (e.g., model 190A of FIG. 1) for dimensionally reducing data, according to certain embodiments.

Referring to FIG. 4C, at block 420 of method 400C, the processing logic receives metrology data (e.g., current metrology data) associated with substrates produced by manufacturing equipment. The manufacturing equipment may be the same as or different from the manufacturing equipment that produced the substrates in block 410 of FIG. 4B. (e.g., associated with the metrology data of which was used to train the machine learning model). The metrology data of block 420 may be received from metrology tools (e.g., metrology equipment 128 of FIG. 1), or from memory (e.g., data store 140 of FIG. 1). In some embodiments, the metrology data of FIG. 4C is the same as the metrology data of FIG. 4B. For example, the model can reduce first metrology data in FIG. 4B to be used in subsequent modeling. In some embodiments, FIG. 4B trains a machine learning model on first metrology data to generate a first trained machine learning model and then FIG. 4C uses the trained machine learning model on second metrology data that is different from the first metrology data.

At block 422, the processing logic may pre-process the metrology data. This may include truncating data, grouping data, combining data, etc. The operations performed at this block may correspond to those performed at block 412 of FIG. 4B.

At block 424, the processing logic provides the (possibly pre-processed) metrology data as input to a trained machine learning model (e.g., model 190A of FIG. 1). The trained machine learning model may have been trained to reduce the dimensionality of the input to output compressed data (e.g., the input data expressed in a compressed form).

At block 426, the processing logic obtains, from the trained machine learning model, the compressed data. The compressed data corresponds to the data input (e.g., current metrology data), expressed in a compressed form with reduced dimensionality.

At block 428, the processing logic causes, based on the compressed data, performance of one or more corrective actions associated with the manufacturing equipment. In some embodiments, the corrective action may be chosen based on the output (e.g., see FIG. 4E) from a second trained machine learning model that is trained (e.g., see FIG. 4D) based on the compressed data obtained in block 426.

FIG. 4D is a method 400D for training a machine learning model (e.g., model 190B of FIG. 1) for determining predictive data to cause performance of a corrective action, according to certain embodiments.

Referring to FIG. 4D, at block 440 of method 400D, the processing logic receives compressed data (e.g., compressed historical metrology data) associated with a set of substrates. The compressed data is received from a trained machine learning model (e.g., model 190A of FIG. 1, trained machine learning model of FIG. 4C). The compressed data may be retrieved by the processing logic from memory (e.g., data store 140 of FIG. 1), rather than directly from the other machine learning model. In some cases, more than one machine learning model may be part of a single compound machine learning model. In this case, training one component of this compound model may involve receiving output from another component of the model as training input to the component of the model to be trained.

At block 442, the processing logic receives historical data associated with the manufacturing of the set of substrates. The historical data may be historical sensor data, historical manufacturing parameters, and/or other historical data associated with the manufacturing of the substrates (e.g., that provides information about the processing conditions of the substrates). The historical data is mapped to the compressed metrology data received at block 440. The historical data associated with the manufacturing of the substrates may be subject to pre-processing (not shown).

At block 444, the processing logic trains a machine learning model using input data including the historical data (e.g., historical sensor data, historical manufacturing parameters, etc.) and target output data of the compressed data received at block 440 to generate a trained machine learning model.

In some embodiments, the trained machine learning model, may be further trained or re-trained using additional input data (e.g., sensor data, manufacturing parameters) and additional compressed data associated with additional substrates. The further training or re-training may account for or predict drift in the manufacturing equipment, sensors, metrology equipment, etc., to predict failure of equipment, to reflect changes to procedures or recipes, etc.

FIG. 4E is a method 400E for using a trained machine learning model (e.g., model 190B of FIG. 1) for determining predictive data.

Referring to FIG. 4E, at block 460 of method 400E, the processing logic receives current data (e.g., sensor data, manufacturing parameters) associated with substrate manufacturing process. In some embodiments, the data is sensor data associated with substrates produced by manufacturing equipment. For example, the sensor data may include temperature values, pressure values, etc. determined by sensors in a processing chamber of the manufacturing equipment. In some embodiments, the data is manufacturing parameters associated with substrates produced or to be produced by manufacturing equipment. For example, the manufacturing parameters may be the setpoints in a process recipe that was used to produce substrates or is to be used to produce substrates.

At block 462, the processing logic provides the current data as input to a trained machine learning model. The current data may be of the same or similar type as the historical data of blocks 442-444 of method 400D of FIG. 4D that was used to train the machine learning model.

At block 464, the processing logic obtains, from the trained machine learning model, one or more outputs indicative of predictive data. In some embodiments, the predictive data may be predicted metrology data, expressed in a compressed form.

At block 466, the processing logic causes performance of a corrective action. In some embodiments, the corrective action may be performed based on the output of the trained machine learning model after the output has been further processed (e.g., after metrology data has been reconstructed from the compressed data that is output by the trained machine learning model). In some embodiments, the type of data that is compressed, and what type of data is provided to the trained machine learning model as input and as target output, vary. Utilizing metrology data compressed in a non-linear way by a trained machine learning model provides a technical advantage in many different contexts. As such, the types of corrective actions that are consistent with this disclosure can vary broadly. In some embodiments, the performance of the corrective action may include one or more of: providing an alert to a user; interrupting functionality of the manufacturing equipment; updating manufacturing parameters, including process parameters and/or hardware parameters; planning replacement of a component of the manufacturing equipment; causing one or more components to be in a sleep mode or an idle mode at particular times during manufacturing of the products to reduce energy usage; replacement of one or more components to reduce energy usage; causing preventative maintenance; causing a modification of the components (e.g., tightening mounting fasteners, replacing binding, etc.); correcting for sensor drift of sensors associated with the manufacturing equipment; correcting for chamber drift; updating a process recipe, or the like. The predictive data and/or corrective action may be indicative of a combination (e.g., combination of components, combination of manufacturing parameters) that is causing abnormalities (e.g., where just one of the items from the combination may not cause the abnormality by its own).

Although some embodiments of FIGS. 4A-E are associated with compressing metrology data and using the compressed metrology data as target output, in some embodiments, the input data (e.g., sensor data, manufacturing parameters, etc.) are compressed and the compressed input data is input into the machine learning model or the trained machine learning model. In some embodiments, the target output (e.g., metrology data) and/or input data (e.g., sensor data, manufacturing parameters, etc.) are compressed for the training and/or using of the machine learning model.

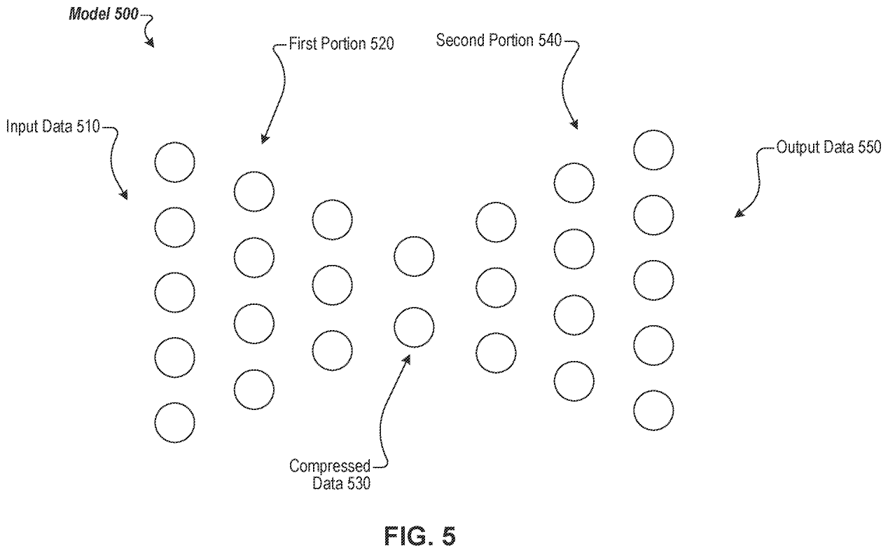

FIG. 5 is a diagram of the operations of a model 500 (e.g., machine learning model) that is capable of reducing the dimensionality of input data, according to certain embodiments.

Input data 510 of model 500 is data associated with production of a substrate. In some embodiments, input data 510 includes one or more of metrology data, manufacturing parameters, sensor data, or combinations thereof. Input data 510 may be pre-processed data. In some embodiments, input data 510 is metrology data associated with a substrate. Metrology data can be of any (or many) types, including thickness, in-plane displacement, chemical characteristics, electronic characteristics, optical characteristics, etc.

The model 500 includes a first portion 520 (e.g., an encoder) and a second portion (e.g., decoder). In some embodiments, the model is one or more of an autoencoder, a convolutional neural network model, etc. The first portion 520 dimensionally reduces the input data 510 (e.g., metrology data) to a compressed form (e.g., compressed data 530). During training of the machine learning model 500, the first portion 520 may find functions to fit input data 510 without guidance from a user. The reducing (e.g., compressing, encoding) may take place over several stages (i.e. convert input data 510 to partially compressed data first, then further to compressed data 530), or reducing (e.g., compressing, encoding) may be done in a single stage.

Second portion 540 takes as input compressed data 530 and produces output data 550 (e.g., reconstructed data 169 of FIG. 1). During training, model 500 is trained to minimize the difference between input data 510 and output data 550, where output 550 is a reconstruction of input data 510 from compressed data 530. The minimization function used to train model 500 may also enforce penalties on the dimensionality of compressed data 530, to avoid returning a function with insufficient compression (e.g., the identity function, which perfectly recreates input data 510 but does not compress the data to a reduced dimensionality).

The function(s) utilized by the first portion 520 and the second portion 540 may be non-linear in nature. All processes of model 500 (i.e., both reduction and reconstruction, both encoding and decoding, etc.) may be used in some applications. In other applications, only some capabilities may be utilized. For example, while training, model 500 may pass input data 510 through first portion 520 to form compressed data 530, then through second portion 540 to determine output data 550, which is then compared to input data 510 to determine the output data 550 is substantially similar to the input data 510. In some embodiments, while using model 500, only some of these actions may be used. First portion 520 may be used to compress input data 510, and model 500 may produce as output compressed data 530. In other embodiments, second portion 540 may be used to reconstruct data based on using a compressed data 530 as input, the reconstructed full-dimensional data being provided as output data 550.

By way of example, in some embodiments a user may utilize a predictive model, where full dimensional output data from the predictive model is inconvenient or impossible. In this case, trained model 500 may be used to output compressed data 530 from a variety of inputs 510, and the set of compressed data 530 may be used as target output to train a predictive machine learning model. Once the predictive model is trained, the predictive model may be used to produce some output data, which will be expressed in a compressed form. The data in compressed form may then be reconstructed by second portion 540 to produce output data 550. The output data may be a reflection of the quality of the low dimensional representation of compressed data 530 (e.g., how similar the input data 510 and the output data 550 are to each other is a reflection of how accurate the compressed data 530 is). The model 500 can then be used by a processing device or a user to perform some corrective action. In some embodiments, model 500 may include an artificial neural network. In some embodiments, model 500 may further include a deep learning network. Model 500 may include a convolutional neural network, a deep belief network, a feedforward neural network, or a multilayer neural network. A processing device may receive, from the predictive model, one or more outputs indicative of predictive data. The predictive data may indicate one or more of: predicted abnormalities in products; predicted abnormalities in components of the manufacturing equipment; predicted energy usage; predicted component failure; or the like. The predictive data may indicate a variation (e.g., from chamber matching for product-to-product uniformity) that is causing an abnormality in the product and/or manufacturing equipment. For example, abnormal characteristics of the manufacturing equipment (e.g., increased energy, drift over time, high number of motor cycles, etc.) may be indicative that a corrective action is to be performed. Utilizing compressed data in the training and use of a second predictive model presents several technical advantages, such as reduced processor load, and training using smaller data sets than may be done using uncompressed data.

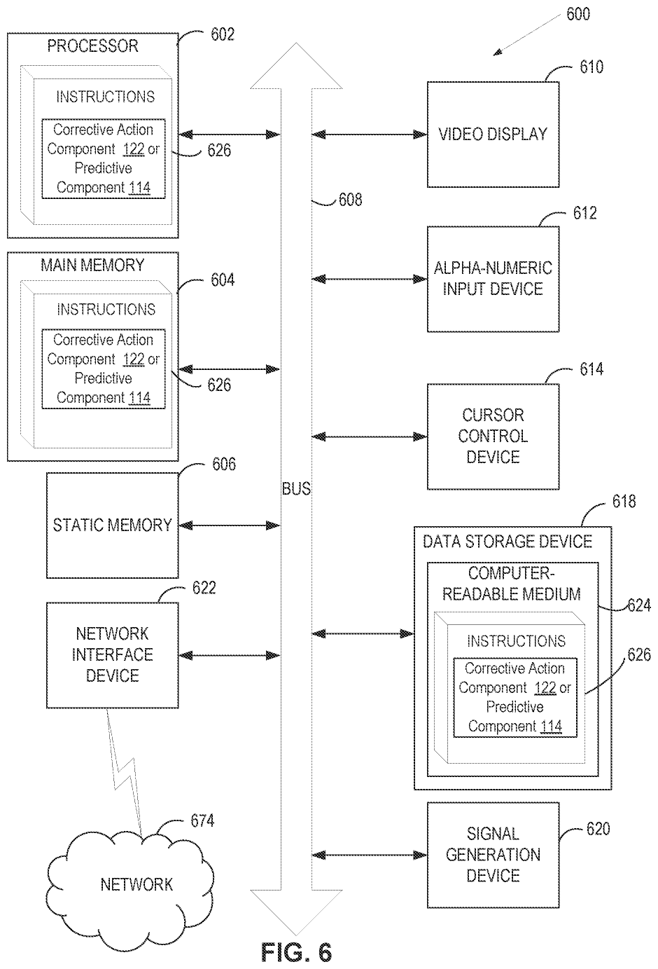

FIG. 6 is a block diagram illustrating a computer system 600, according to certain embodiments. In some embodiments, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., Random Access Memory (RAM)), a non-volatile memory 606 (e.g., Read-Only Memory (ROM) or Electrically-Erasable Programmable ROM (EEPROM)), and a data storage device 618, which may communicate with each other via a bus 608.

Processing device 602 may be provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 600 may further include a network interface device 622 (e.g., coupled to network 674). Computer system 600 also may include a video display unit 610 (e.g., an LCD), an alphanumeric input device 612 (e.g., a keyboard), a cursor control device 614 (e.g., a mouse), and a signal generation device 620.

In some embodiments, data storage device 618 may include a non-transitory computer-readable storage medium 624 (e.g., non-transitory machine-readable medium) on which may store instructions 626 encoding any one or more of the methods or functions described herein, including instructions encoding components of FIG. 1 (e.g., predictive component 114, model 190, etc.) and for implementing methods described herein.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICs, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “performing,” “providing,” “obtaining,” “causing,” “accessing,” “determining,” “adding,” “using,” “training,” “reducing,” “generating,” “correcting,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may include a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and embodiments, it will be recognized that the present disclosure is not limited to the examples and embodiments described. The scope of the disclosure should be determined with reference to the following claims, along with the full scope of equivalents to which the claims are entitled.

1. A method comprising:
receiving first metrology data associated with a first plurality of substrates produced by first manufacturing equipment; and
training a first machine learning model with data input comprising the first metrology data to generate a first trained machine learning model, the first trained machine learning model being capable of reducing dimensionality of second metrology data associated with a second plurality of substrates produced by second manufacturing equipment to perform one or more corrective actions associated with the second manufacturing equipment.

2. The method of claim 1, wherein the training of the first machine learning model comprises:
reducing dimensionality of the first metrology data to form first compressed data; and
generating, based on the first compressed data, first reconstructed data that is substantially similar to the first metrology data.

3. The method of claim 1, wherein:
the first trained machine learning model is capable of reducing dimensionality of the second metrology data to generate second compressed data; and
a second machine learning model is to be trained based on second data input comprising current data associated with production of the second plurality of substrates and target output comprising the second compressed data to perform the one or more corrective actions.

4. The method of claim 3, wherein the current data comprises one or more of sensor data or manufacturing parameters.

5. The method of claim 3, wherein the one or more corrective actions comprise one or more of:
providing an alert to a user;
updating process parameters of the manufacturing equipment;
updating hardware parameters of the manufacturing equipment;
correcting sensor drift of sensors associated with the manufacturing equipment;
correcting chamber drift associated with the manufacturing equipment; or
updating a process recipe to produce subsequent substrates.

6. The method of claim 2, wherein the reducing of the dimensionality of the first metrology data is via non-linear fit.

7. The method of claim 1, wherein the first metrology data comprises one or more of thickness data or in-plane displacement data.

8. The method of claim 1, wherein the first machine learning model is a convolutional neural network model.

9. A method comprising:
receiving metrology data associated with a plurality of substrates produced by manufacturing equipment;
providing the metrology data as input to a first trained machine learning model to reduce dimensionality of the metrology data to generate compressed data;
obtaining, from the first trained machine learning model, the compressed data; and
causing, based on the compressed data, performance of one or more corrective actions associated with the manufacturing equipment.

10. The method of claim 9, the first trained machine learning model being trained by reducing dimensionality of historical metrology data to produce historical compressed data and generating, based on the historical compressed data, reconstructed data that is substantially similar to the historical metrology data.

11. The method of claim 9, wherein a second machine learning model is to be trained based on data input comprising current data associated with producing the plurality of substrates by the manufacturing equipment and target output comprising the compressed data to perform the one or more corrective actions.

12. The method of claim 11, wherein the current data comprises one or more of sensor data or manufacturing parameters.

13. The method of claim 9, wherein the one or more corrective actions comprise one or more of:
providing an alert to a user;
updating process parameters of the manufacturing equipment;
updating hardware parameters of the manufacturing equipment;
correcting sensor drift of sensors associated with the manufacturing equipment;
correcting chamber drift associated with the manufacturing equipment; or
updating a process recipe to produce subsequent substrates.

14. The method of claim 9, wherein the metrology data comprises one or more of thickness data or in-plane displacement data.

15. The method of claim 9, wherein the first trained machine learning model comprises a convolutional neural network model.

16. A non-transitory machine-readable storage medium storing instructions which, when executed cause a processing device to perform operations comprising:
receiving first metrology data associated with a first plurality of substrates produced by first manufacturing equipment; and
training a first machine learning model with data input comprising the first metrology data to generate a first trained machine learning model, the first trained machine learning model being capable of reducing dimensionality of second metrology data associated with a second plurality of substrates produced by second manufacturing equipment to perform one or more corrective actions associated with the second manufacturing equipment.

17. The non-transitory machine-readable medium of claim 16, wherein the training of the first machine learning model comprises:
reducing dimensionality of the first metrology data to form first compressed data; and
generating, based on the first compressed data, first reconstructed data that is substantially similar to the first metrology data.

18. The non-transitory machine-readable medium of claim 16, wherein:
the first trained machine learning model is capable of reducing dimensionality of the second metrology data to generate second compressed data; and
a second machine learning model is to be trained based on second data input comprising current data associated with production of the second plurality of substrates and target output comprising the second compressed data to perform the one or more corrective actions, wherein the current data comprises one or more of sensor data or manufacturing parameters.

19. The non-transitory machine-readable medium of claim 17, wherein the reducing of the dimensionality of the first metrology data is via a non-linear fit.

20. The non-transitory machine-readable medium of claim 16, wherein the first machine learning model comprises one or more of a convolutional neural network model, a deep belief network, a feedforward neural network, a multilayer neural network, or an autoencoder.
